(19) United States
(12) Patent Application Publication
(10) Pub. No.: US 2023/0266973 A1
(43) Pub. Date: Aug. 24, 2023

(54) LOCAL DATA STREAM ACCELERATION METHOD, DATA STREAM ACCELERATION SYSTEM, COMPUTER DEVICE AND STORAGE MEDIUM

(71) Applicant: SHENZHEN CORERAIN TECHNOLOGIES CO., LTD, Guangdong (CN)

(72) Inventors: Yongqing WU, Guangdong (CN); Hao JIANG, Guangdong (CN); Kuenhung Tsoi, Shenzhen (CN); Xinyu NIU, Guangdong (CN)

(73) Assignee: Shenzhen Corerain Technologies Col., Ltd., Shenzhen (CN)

(21) Appl. No.: 17/768,247

(22) PCT Filed: Oct. 12, 2019
(86) PCT No.: PCT/CN2019/110815

§ 371 Date: Apr. 12, 2022

(51) Int. Cl. G06F 9/38; G06F 9/445

(52) U.S. Cl. CPC G06F 9/3877; G06F 9/44505

(57) ABSTRACT

Provided are a local data stream acceleration method, a data stream acceleration system, a computer device and a storage medium. The method includes the following: receiving a raw data stream collected by a data acquisition device and performing preliminary processing on the raw data stream; configuring a local data stream acceleration engine, inputting the preliminarily processed raw data stream into the data stream acceleration engine for acceleration processing, and obtaining a result of data stream acceleration processing; and outputting the result of data stream acceleration processing. The data stream acceleration engine is configured dynamically and locally according to the type of the obtained data stream, and the data stream is accelerated by the dynamically configured local data stream acceleration engine.

### TECHNICAL FIELD

The present disclosure relates to the field of data processing technology and in particular to a local data stream acceleration method, a data stream acceleration system, a computer device and a storage medium.

### BACKGROUND

Traditional front-end devices, such as various single-chip microcomputers, and embedded devices, generally only perform data acquisition work due to limits of computing power, then the acquired data is stored in some kind of storage medium, the data is eventually transmitted to remote servers through a network, and a server having high computing power may carry out data processing work. But this manner is not real-time and is severely limited in application scenarios requiring real-time performance.

In addition, there is a large amount of data transmission between front-end devices and a server. Some of the data transmission is in an offline form, in such a case the front-end devices may need to be turned off, then a storage medium is taken out, and there may be a period when the front-end devices do not work; some of the data transmission may be carried out through 3rd-generation (3G)/4th generation mobile communication technology (4G) or other carrier networks for data communication, but generally speaking, the tariff for this kind of data communication is relatively high, and a large amount of data transmission may have the problem of high costs.

### SUMMARY

An object of the present disclosure is to provide a local data stream acceleration method, a data stream acceleration system, a computer device and a storage medium, to improve the real-time performance of data processing and analysis and reduce the cost of data transmission.

In order to solve the above technical problem, the present disclosure provides a local data stream acceleration method, which adopts the technical scheme described below.

The local data stream acceleration method includes the following steps. A raw data stream collected by a data acquisition device is received and preliminary processing is performed on the raw data stream; a local data stream acceleration engine is configured, the preliminarily processed raw data stream is inputted into the data stream acceleration engine for acceleration processing, and a result of data stream acceleration processing is obtained; and the result of data stream acceleration processing is outputted.

Further, the raw data stream includes an audio and video data stream and a text data stream, and the step in which the preliminary processing is performed on the raw data stream includes encoding, decoding and vectorizing the audio and video data stream and the text data stream.

Further, the step in which the local data stream acceleration engine is configured, and the preliminarily processed raw data stream is inputted into the data stream acceleration engine for acceleration processing includes that a configuration instruction is transmitted to the data stream acceleration engine for configuration via a control channel; and the raw data stream is inputted to the configured data stream acceleration engine for acceleration via a data channel.

Further, the configuration of the data stream acceleration engine includes software configuration and hardware configuration, and the step in which the configuration instruction is transmitted to the data stream acceleration engine for configuration via the control channel includes performing the software configuration and hardware configuration of the data stream acceleration engine, and the step of performing the software configuration and hardware configuration of the data stream acceleration engine includes the following. A corresponding software configuration instruction and a corresponding hardware configuration instruction are generated according to a type of the data stream; and the software configuration instruction and the hardware configuration instruction are transmitted via the control channel to perform the software configuration and the hardware configuration on the data stream acceleration engine.

In order to solve the above technical problem, the present disclosure also provides a local data stream acceleration device, which adopts the technical scheme described below.

The local data stream acceleration device includes a reception module configured to receive a raw data stream collected by a data acquisition device and perform preliminary processing on the raw data stream; an acceleration module configured to configure a local data stream acceleration engine, input the preliminarily processed raw data stream into the data stream acceleration engine for acceleration processing, and obtain a result of data stream acceleration processing; and an output module configured to output the result of data stream acceleration processing.

In order to solve the above technical problem, the present disclosure also provides a data stream acceleration system, which adopts the technical scheme described below.

The data stream acceleration system includes a data acquisition module configured to collect data and perform preliminary processing on a data stream, a data storage module configured to store a data stream collected by the data acquisition module, a data acceleration engine module configured to perform acceleration on the data stream, and a main control module configured to control data acquisition, data storage and data acceleration.

Further, the main control module performs the local data stream acceleration method of any one of claims 1 to 4 and implements a corresponding function.

Further, all modules of the system are integrated into a single computer device or distributed to different computer devices to form a distributed data stream acceleration system.

In order to solve the above technical problem, the present disclosure also provides a computer device, which adopts the technical scheme described below.

The computer device includes a memory and a processor, and the memory stores computer programs, and the processor, when executing the computer programs, performs any one of the functions of the artificial intelligence application development system provided by the present disclosure.

In order to solve the above technical problem, the present disclosure also provides a computer-readable storage medium, which adopts the technical scheme described below.

The computer-readable storage medium stores computer programs, and the computer programs, when executed by a processor, perform any one of the functions of the artificial intelligence application development system provided by the present disclosure.

Compared with the related art, the present disclosure has the main beneficial effects as described below: in the present disclosure, the data stream acceleration engine is configured dynamically and locally according to the type of the obtained data stream, and the data stream is accelerated by the dynamically configured local data stream acceleration engine, which can improve the real-time performance of data stream processing and analysis and reduce the cost of data transmission.

### BRIEF DESCRIPTION OF DRAWINGS

In order to more clearly illustrate the solutions of the present disclosure, the following is a brief description of accompanying drawings that need to be used in the description of embodiments of the present disclosure. Apparently, the accompanying drawings in the following description are some embodiments of the present disclosure, and a person skilled in the art is able to obtain other drawings according to the accompanying drawings without the use of inventive work.

FIG. 1 shows a flowchart of an embodiment of a local data stream acceleration method according to embodiments of the present disclosure;

FIG. 2 shows a structure diagram of a local data stream acceleration device according to an embodiment of the present disclosure;

FIG. 3 shows a structure diagram of an embodiment of a data stream acceleration system according to embodiments of the present disclosure; and

FIG. 4 is a structure diagram of an embodiment of a computer device according to embodiments of the present disclosure.

### DETAILED DESCRIPTION

Unless otherwise defined, all technical and scientific terms used herein have the same meaning as those commonly understood by those skilled in the art to which the present disclosure pertains. The terms used herein in the specification of the disclosure are intended only for the purpose of describing specific embodiments and are not intended to limit the present disclosure. The term “including”, “comprising”, or any their variation, used in the specification, the claims and the above brief description of drawings of the present disclosure, is intended to cover a non-exclusive inclusion. The term “first”, “second”, or the like, in the specification, claims or drawings of the present disclosure, is used to distinguish between different objects and is not intended to describe a particular order.

Reference herein to “embodiment” means that particular features, structures or characteristics described in the embodiment may be included in at least one embodiment of the present disclosure. The appearance of phrases in various places in the specification is not necessarily referring to the same embodiment, nor necessarily referring to an independent embodiment or an alternative embodiment that is mutually exclusive with other embodiments. Those skilled in the art can explicitly and implicitly understand that the embodiments described herein may be combined with other embodiments.

In order to provide those skilled in the art with a better understanding of the schemes of the present disclosure, the following is a clear and complete description of the technical schemes in embodiments of the present disclosure, in conjunction with the accompanying drawings.

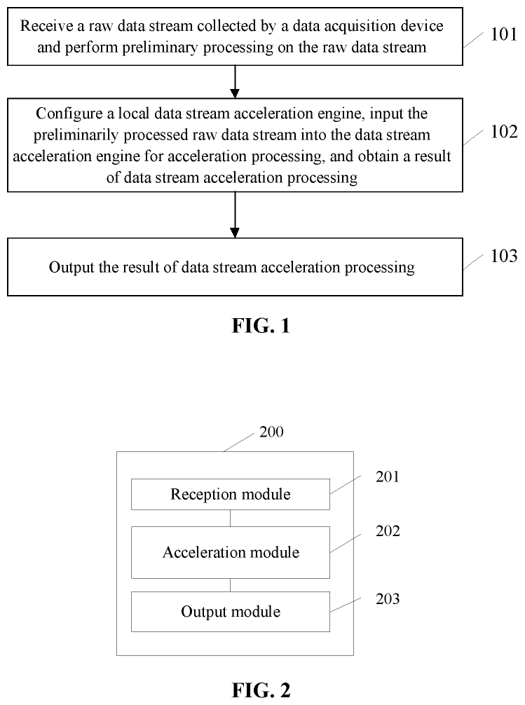

In a first aspect, referring to FIG. 1, FIG. 1 shows a flowchart of an embodiment of a local data stream acceleration method according to embodiments of the present disclosure. The local data stream acceleration method includes the following.

In step 101, a raw data stream collected by a data acquisition device is received, and preliminary processing is performed on the raw data stream.

In the embodiment, the data acquisition device may be an image acquisition device (such as a camera), an audio acquisition device (such as a microphone, or a recorder), a text scanning device, or the like, through which a corresponding type of raw data, including audio data, video data, text data, or the like, may be collected in a particular scenario. Further, this data is required to be preliminarily processed such as encoding, decoding, and even vectorization, according to certain rules, and then the processed data is stored in a data buffer to accelerate data access.

In step 102, a local data stream acceleration engine is configured, the preliminarily processed raw data stream is inputted into the data stream acceleration engine for acceleration processing, and a result of data stream acceleration processing is obtained.

In the embodiment, the local data stream acceleration engine is a local hardware module configured to perform data acceleration processing, and software and hardware of the local data stream acceleration engine may be dynamically configured according to different application scenarios, so that the data stream acceleration engine can be switched in different application scenarios to achieve local dynamic scheduling of software and hardware resources required for acceleration of different types of data streams in different scenarios, and uploading the data stream to a server for processing is not needed, thereby improving the real-time performance and efficiency of data stream acceleration.

The above data stream acceleration engine receives a configuration instruction from a control channel for the corresponding configuration. For example, in a target recognition application scenario, software configuration such as network structure parameters of a neural network of the data stream acceleration engine is performed, and then hardware configuration of hardware computing resources required by the neural network of the data stream acceleration engine is implemented. After the above configuration, the data stream acceleration engine receives a certain type of input data stream from a data channel, and obtains the corresponding processing result after accelerated computational processing. The above data stream acceleration engine supports multiple forms of data processing, and the data stream acceleration engine may dynamically configure and switch its function and have scalability. In addition, the data stream acceleration engine supports a custom data processing mode to a certain extent, users may implement their own data processing mode in a supported manner according to demand, thus further improving adaptability of the data stream acceleration engine. For example, for structured data (such as extensible markup language (XML) text data), the processing manner for this type of data may be customized according to characteristics of the XML structure.

In step 103, the result of data stream acceleration processing is outputted.

In the embodiment, the data after acceleration processing implemented by the data stream acceleration engine, such as feature data after feature extraction implemented by a neural network, may be obtained in step 102, and then the processed data is returned through the data channel from the data stream acceleration engine and further outputted to other systems or devices for use.

In embodiments of the present disclosure, a local data stream acceleration method is provided, the method includes the following steps: a raw data stream collected by a data acquisition device is received and preliminary processing is performed on the raw data stream; a local data stream acceleration engine is configured, the preliminarily processed raw data stream is inputted into the data stream acceleration engine for acceleration processing, and a result of data stream acceleration processing is obtained; and the result of data stream acceleration processing is outputted. The data stream acceleration engine is configured dynamically and locally according to the type of the obtained data stream, and the data stream is accelerated by the dynamically configured local data stream acceleration engine, which can improve the real-time performance of data stream processing and analysis and reduce the cost of data transmission.

Further, the raw data stream includes an audio and video data stream and a text data stream, and the preliminary processing performed on the raw data stream includes encoding, decoding and vectorization of the audio and video data stream and the text data stream.

In an embodiment, the raw data stream such as the audio and video data stream, and the text data stream may be collected by different data acquisition devices and decoded according to an encoding format of the raw data, and then preliminary processing such as the vectorization is carried out to conform to the format of input data of the local data stream acceleration engine.

Further, the step in which the local data stream acceleration engine is configured, and the preliminarily processed raw data stream is inputted into the data stream acceleration engine for acceleration processing includes the steps described below, a configuration instruction is transmitted to the data stream acceleration engine for configuration via a control channel; and a raw data stream is inputted to the configured data stream acceleration engine for acceleration via a data channel.

In the present embodiment, the local data stream acceleration engine may be dynamically configured according to different types of data collected in different application scenarios, so as to switch data processing modes. For example, in an application scenario of speech recognition, the above local data stream acceleration engine may be configured as a pre-trained neural network model for speech processing, such as a recurrent neural network (RNN). In an object detection scenario, the above local data stream acceleration engine may be configured as a pre-trained neural network model for image processing, such as a fast region-based convolutional neural network (fast-RCNN). The configuration instruction may be transmitted via the control channel to the data stream acceleration engine for configuration, and the configuration instruction is an instruction for configuring the specific model structure of the above data stream acceleration engine, such as an instruction for a network structure parameter of the above neural network model. The control channel is a channel for transmitting a control instruction between the control channel and the data stream acceleration engine, and the control channel is generally implemented as a protocol through which functions (such as an implementation of which type of data processing) and a state (such as starting, pausing data processing, or adjusting engine parameters) of the data stream acceleration engine may be switched. The data channel is a channel for transmitting data between the data channel and the data stream acceleration engine, and the data channel may be in various forms according to an actual situation, for example, in the form of a software protocol, such as transmission control protocol (TCP)/Internet protocol (IP), or in the form of a direct connection of hardware using a certain specification of link, such as BT1120, inter-integrated circuit (I2C), and universal asynchronous receiver/transmitter (UART). The data channel is a bi-directional channel, and data may be passed to the data stream acceleration engine through the data channel. After processing the data, the data stream acceleration engine may also return a data processing result through the data channel for further processing.

Further, the configuration of the data stream acceleration engine includes software configuration and hardware configuration, and the step of transmitting the configuration instruction to the data stream acceleration engine for configuration via the control channel includes the software configuration and hardware configuration of the data stream acceleration engine, and the software configuration and hardware configuration of the data stream acceleration engine include the steps described below, a corresponding software configuration instruction and a corresponding hardware configuration instruction are generated according to a type of the data stream; and the software configuration instruction and the hardware configuration instruction are transmitted via a control channel to perform the software configuration and the hardware configuration on the data stream acceleration engine.

In the present embodiment, different types of data streams may be collected by different data acquisition devices, and different types of data streams have different data processing modes, and the data stream acceleration engine needs to be configured to conform to different data processing modes. For example, for an image data stream, the data stream acceleration engine needs to be configured as a convolutional neural network (CNN) or the like to perform a feature extraction operation on a two-dimensional image, and for voice data, the data stream acceleration engine needs to be configured as an RNN, a long short-term memory (LSTM), or the like to perform feature extraction on timing data of voice. The configuration instruction may be transmitted via the control channel to the data stream acceleration engine for the corresponding configuration, including software configuration and hardware configuration. A software configuration instruction is for structural parameters of the data stream acceleration engine, or the like, and a hardware configuration instruction is for dynamic allocation of hardware computing resources required for the structure of the data stream acceleration engine, such as the allocation of a computing unit, a storage unit, or a pipeline acceleration unit. Thus, the real-time processing of local data streams is realized, and the cost of data transmission over the network, which is required by remote data processing, decreases.

In a second aspect, referring to FIG. 2, FIG. 2 is a structure diagram of a local data stream acceleration device according to an embodiment of the present disclosure. Referring to FIG. 2, a device 200 includes the following.

A reception module 201 is configured to receive a raw data stream collected by a data acquisition device and perform preliminary processing on the raw data stream.

An acceleration module 202 is configured to configure a local data stream acceleration engine, input the preliminarily processed raw data stream into the data stream acceleration engine for acceleration processing, and obtain a result of data stream acceleration processing.

An output module 203 is configured to output the result of data stream acceleration processing.

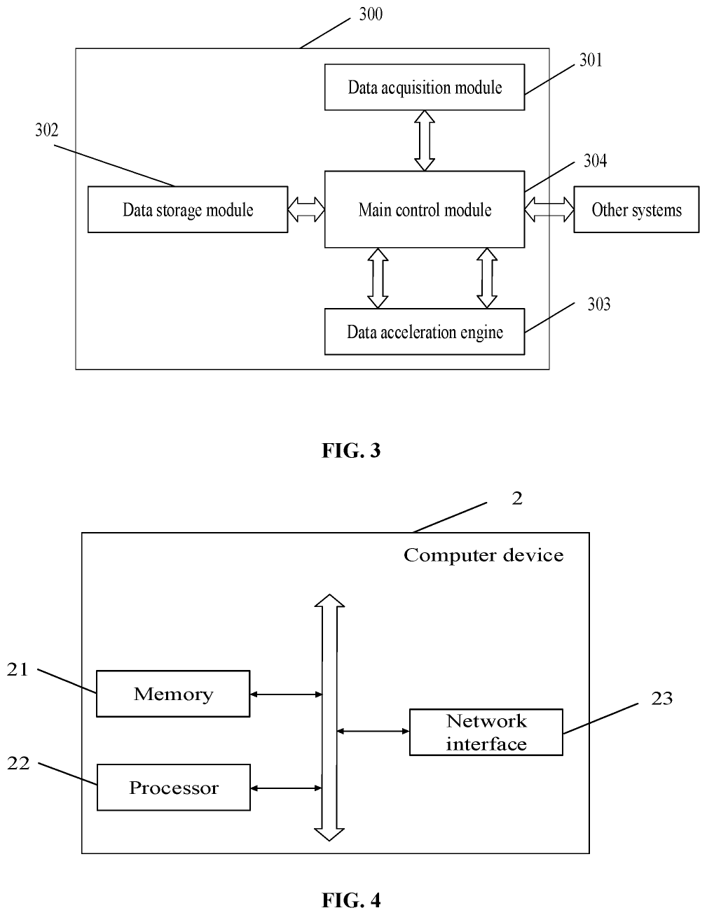

In a third aspect, referring to FIG. 3, FIG. 3 shows a structure diagram of an embodiment of a data stream acceleration system according to the present disclosure. Referring to FIG. 3, the data stream acceleration system 300 includes a data acquisition module 301 configured to collect data and perform preliminary processing on a data stream, a data storage module 302 configured to store the data stream collected by the data acquisition module 301, a data acceleration engine module 303 configured to perform acceleration on the data stream, and a main control module 304 configured to control data acquisition, data storage and data acceleration.

The data acquisition module 301 is responsible for collecting specific information in a scenario, and the specific information may be relatively important in a specific scenario, such as image information, sound information, and other information. The data acquisition module 301 may perform the preliminary processing on the specific data collected to form a certain data format, and then this data is stored in a data buffer, i.e., the data storage module 302. The data storage module 302 is configured to store the data collected by the data acquisition module, and is generally a double data rate (DDR), or some kind of permanent storage devices, such as a secure digital (SD) card, and a hard disk, according to actual demand.

Further, the main control module 304 performs the local data stream acceleration method to implement the corresponding function.

In the present system, the main control module 304 executes the local data stream acceleration method and implements the corresponding function. For example, the main control module 304 is responsible for controlling and scheduling operations of other modules in the whole system, including configuration of other modules, interaction with the data acquisition module, interaction with the data stream acceleration engine, and interaction with other external systems.

It should be noted that all modules in the above data stream acceleration system 300 may be integrated into a single computer device to achieve the acceleration processing of the local data stream, thus improving the real-time nature of data processing to meet the requirements of applications; or all modules in the above data stream acceleration system 300 may be distributed to different computer devices to form a distributed data stream acceleration system.

In a third aspect, an embodiment of the present disclosure provides a computer device, including a memory, a processor, and computer programs that are stored in the memory and executable by the processor. The processor, when executing the computer programs, implements the steps of the local data stream acceleration method provided in embodiments of the present disclosure.

In a fourth aspect, an embodiment of the present disclosure provides a computer-readable storage medium storing computer programs, and the computer programs, when executed by a processor, implement the steps of the local data stream acceleration method provided in embodiments of the present disclosure. In embodiments of the present disclosure, the computer programs in the computer-readable storage medium, when executed by the processor, implement the steps of the local data stream acceleration method, so that the real-time performance of data stream processing and analysis can be improved and the cost of data transmission can be reduced.

Exemplarily, the computer programs of the computer-readable storage medium include computer program codes, and the computer program codes may be in the form of source code, object code or an executable file, or in some intermediate forms, or the like. The computer-readable medium may include: any entity or device capable of carrying the computer program code, a recording medium, a universal serial bus flash disk, a removable hard disk, a diskette, an optical disk, a computer memory, a read-only memory (ROM), a random access memory (RAM), an electric carrier signal, a telecommunication signal, a software distribution media, or the like.

It should be noted that since the computer programs of the computer-readable storage medium, when executed by the processor, implement the steps of the local data stream acceleration method, all embodiments of the local data stream acceleration method described above are applicable to the computer-readable storage medium and can achieve the same or similar beneficial effects.

A person skilled in the art can understand that in order to realize the described embodiments all or part of the process of the method, or all or part of the subsystems of the system, may be accomplished by relevant hardware instructed through a computer program. The computer program may be stored in a computer-readable storage medium, and when the computer program is executed, the functions of embodiments of each subsystem as described above are achieved. The above storage medium may be a non-volatile storage medium such as a disk, an optical disk, a read-only memory (ROM), or a random access memory (RAM).

It is to be understood that, although various subsystems in the structure diagrams in the accompanying drawings are sequentially shown according to an indication of arrows, the subsystems are not necessarily sequentially performed according to the sequence indicated by the arrows. Unless explicitly specified in the specification, execution of the subsystems is not strictly limited in the sequence, and the subsystems may be performed in other sequences. In addition, when executed, at least part of the subsystems in the structure diagrams in the accompanying drawings may include a plurality of substeps or stages. The substeps or the stages are not necessarily performed at the same moment, and may be performed at different moments. The substeps or the stages are not necessarily performed sequentially, and may be performed in turn or alternately with another step, or a substep of another step, or at least part of a stage.

In order to solve the technical problem, an embodiment of the present disclosure further provides a computer device. Referring to FIG. 4, FIG. 4 is a block diagram of a basic structure of the computer device according to an embodiment.

The computer device 2 includes a memory 21, a processor 22 and a network interface 23 which are communicatively connected with one another via a system bus. It is to be noted that figures only illustrate the computer device 2 with components 21 to 23, but it should be understood that it is not required to implement all the illustrated components and more or fewer components may be implemented. Those skilled in the art can understand that the computer device herein is a device capable of automatically performing numerical calculations and/or information processing in accordance with pre-set or stored instructions, whose hardware includes, but is not limited to, a microprocessor, an application specific integrated circuit (ASIC), a field-programmable gate array (FPGA), a digital signal processor (DSP), an embedded device or the like.

The computer device may be a desktop computer, a laptop, a handheld computer, a cloud server, or another computing device. The computer device may interact with a user using a keyboard, a mouse, a remote controller, a touchpad, a voice-activated device, or the like.

The memory 21 includes at least one type of readable storage medium, and the readable storage medium includes a flash memory, a hard disk, a multimedia card, a card-type memory (such as a secure digital (SD) or a data register (DX) memory), a random-access memory (RAM), a static random access memory (SRAM), a read-only memory (ROM), an electrically erasable programmable read-only memory (EEPROM), a programmable read-only memory (PROM), a magnetic memory, a disk, an optical disk, or the like. In some embodiments, the memory 21 may be an internal storage unit of the computer device 2, for example a hard disk or a memory of the computer device 2. In other embodiments, the memory 21 may also be an external storage device of the computer device 2, for example, a plug-in hard disk, a smart media card (SMC), a secure digital (SD) card, and a flash card, which is provided on the computer device 2. Of course, the memory 21 may also include both the internal storage unit and the external storage device which are included by the computer device 2. In this embodiment, the memory 21 is typically configured to store the operating system and various application software installed in the computer device 2, such as program codes for the local data stream acceleration method. In addition, the memory 21 may also be configured to temporarily store various types of data that has been outputted or is outputted.

In some embodiments, the processor 22 may be a central processing unit (CPU), a controller, a microcontroller, a microprocessor, or another data processing chip. The processor 22 is typically used for controlling the overall operation of a computer device 2. In the embodiment, the processor 22 is configured to run program codes stored in the memory 21 or process data, such as running program codes for the local data stream acceleration method.

The network interface 23 may include a wireless network interface or a wired network interface, and the network interface 23 is typically configured to establish a communication connection between the computer device 2 and other electronic devices.

The present disclosure also provides another embodiment, i.e., a computer-readable storage medium. The computer-readable storage medium stores a program of the local data stream acceleration method, and the program of the local data stream acceleration method may be executed by at least one processor so that the at least one processor performs the steps in the program of the local data stream acceleration method described above to achieve the corresponding functions.

Through the description of the foregoing embodiments, a person skilled in the art may clearly understand that the method according to the foregoing embodiments may be implemented by software in addition to a necessary common hardware platform, or may be implemented by hardware. However, in many cases, the former is an alternative implementation. Based on such understanding, the essence of the technical schemes of embodiments of the present disclosure, or the part of the technical schemes of embodiments of the present disclosure contributing to the related art, may be embodied in the form of a software product. The computer software product may be stored in a storage medium (such as a ROM/RAM, a magnetic disk and an optical disk), including several instructions for enabling a terminal device (which may be a mobile phone, a computer, a server, an air conditioner, a network device, or the like) to execute the method provided in embodiments of the present disclosure.

Apparently, the embodiments described above are only part, not all, of embodiments of the present disclosure. The alternative embodiments of the present disclosure are shown in the accompanying drawings but do not limit the scope of the present disclosure. The present disclosure may be implemented in many different forms, and instead, these embodiments are provided for providing a more thorough and comprehensive understanding of the present disclosure. Although the present disclosure has been described in detail through the preceding embodiments, a person skilled in the art also still can modify the technical schemes described in the foregoing embodiments, or make equivalent replacements on some of the technical features. Any equivalent structure made by using the specification of the present disclosure and the accompanying drawings, which is directly or indirectly applied in the related art, is also within the scope of the present disclosure.

1. A local data stream acceleration method, comprising:
receiving a raw data stream collected by a data acquisition device and performing preliminary processing on the raw data stream;
configuring a local data stream acceleration engine, inputting the preliminarily processed raw data stream into the data stream acceleration engine for acceleration processing, and obtaining a result of data stream acceleration processing; and
outputting the result of data stream acceleration processing.

2. The method of claim 1, wherein the raw data stream comprises an audio and video data stream and a text data stream, and
performing the preliminary processing on the raw data stream comprises:
encoding, decoding and vectorizing the audio and video data stream and the text data stream.

3. The method of claim 2, wherein configuring the local data stream acceleration engine, and inputting the preliminarily processed raw data stream into the data stream acceleration engine for the acceleration processing comprise:
transmitting, via a control channel, a configuration instruction to the data stream acceleration engine for configuration; and
inputting, via a data channel, the raw data stream to the configured data stream acceleration engine for acceleration.

4. The method of claim 3, wherein the configuration of the data stream acceleration engine comprises software configuration and hardware configuration, and
transmitting, via the control channel, the configuration instruction to the data stream acceleration engine for configuration comprises: performing the software configuration and hardware configuration of the data stream acceleration engine, wherein performing the software configuration and hardware configuration of the data stream acceleration engine comprises:
generating, according to a type of the data stream, a corresponding software configuration instruction and a corresponding hardware configuration instruction; and
transmitting, via the control channel, the software configuration instruction and the hardware configuration instruction to perform the software configuration and the hardware configuration on the data stream acceleration engine.

5. A local data stream acceleration device, comprising:
a reception module configured to receive a raw data stream collected by a data acquisition device and perform preliminary processing on the raw data stream;
an acceleration module configured to configure a local data stream acceleration engine, input the preliminarily processed raw data stream into the data stream acceleration engine for acceleration processing, and obtain a result of data stream acceleration processing; and
an output module configured to output the result of data stream acceleration processing.

6. A data stream acceleration system, comprising: a data acquisition module configured to collect a data stream and perform preliminary processing on the data stream, a data storage module configured to store the data stream collected by the data acquisition module, a data acceleration engine module configured to perform acceleration on the data stream, and a main control module configured to control data acquisition, data storage and data acceleration.

7. The system of claim 6, wherein the main control module is configured to perform the following steps:
receiving a raw data stream collected by the data acquisition module and performing preliminary processing on the raw data stream;
configuring a local data stream acceleration engine, inputting the preliminarily processed raw data stream into the data stream acceleration engine for acceleration processing, and obtaining a result of data stream acceleration processing; and
outputting the result of data stream acceleration processing.

8. The system of claim 7, wherein all modules in the system are integrated into a single computer device or distributed to different computer devices to form a distributed data stream acceleration system.

9. A computer device, comprising a memory and a processor, wherein the memory stores computer programs, and the processor, when executing the computer programs, performs the local data stream acceleration method of claim 1.

10. A non-transitory computer-readable storage medium, wherein the computer-readable storage medium stores computer programs, and the computer programs, when executed by a processor, perform the local data stream acceleration method of claim 1.

11. The system of claim 7, wherein the raw data stream comprises an audio and video data stream and a text data stream, and
the main control module is configured to execute performing the preliminary processing on the raw data stream by:
encoding, decoding and vectorizing the audio and video data stream and the text data stream.

12. The system of claim 11, wherein the main control module is configured to perform configuring the local data stream acceleration engine, and inputting the preliminarily processed raw data stream into the data stream acceleration engine for the acceleration processing by:
transmitting, via a control channel, a configuration instruction to the data stream acceleration engine for configuration; and
inputting, via a data channel, the raw data stream to the configured data stream acceleration engine for acceleration.

13. The system of claim 12, wherein the configuration of the data stream acceleration engine comprises software configuration and hardware configuration, and
the main control module is configured to perform transmitting, via the control channel, the configuration instruction to the data stream acceleration engine for configuration by: performing the software configuration and hardware configuration of the data stream acceleration engine, wherein the main control module is configured to execute performing the software configuration and hardware configuration of the data stream acceleration engine by:
generating, according to a type of the data stream, a corresponding software configuration instruction and a corresponding hardware configuration instruction; and
transmitting, via the control channel, the software configuration instruction and the hardware configuration instruction to perform the software configuration and the hardware configuration on the data stream acceleration engine.

14. The computer device of claim 9, wherein the raw data stream comprises an audio and video data stream and a text data stream, and
the processor executes performing the preliminary processing on the raw data stream by:
encoding, decoding and vectorizing the audio and video data stream and the text data stream.

15. The computer device of claim 14, wherein the processor executes configuring the local data stream acceleration engine, and inputting the preliminarily processed raw data stream into the data stream acceleration engine for the acceleration processing by:
transmitting, via a control channel, a configuration instruction to the data stream acceleration engine for configuration; and
inputting, via a data channel, the raw data stream to the configured data stream acceleration engine for acceleration.

16. The computer device of claim 15, wherein the configuration of the data stream acceleration engine comprises software configuration and hardware configuration, and
the processor executes transmitting, via the control channel, the configuration instruction to the data stream acceleration engine for configuration by: performing the software configuration and hardware configuration of the data stream acceleration engine, wherein the processor executes performing the software configuration and hardware configuration of the data stream acceleration engine by:
generating, according to a type of the data stream, a corresponding software configuration instruction and a corresponding hardware configuration instruction; and
transmitting, via the control channel, the software configuration instruction and the hardware configuration instruction to perform the software configuration and the hardware configuration on the data stream acceleration engine.

17. The storage medium of claim 10, wherein the raw data stream comprises an audio and video data stream and a text data stream, and
the computer programs execute performing the preliminary processing on the raw data stream by:
encoding, decoding and vectorizing the audio and video data stream and the text data stream.

18. The storage medium of claim 17, wherein the computer programs perform configuring the local data stream acceleration engine, and inputting the preliminarily processed raw data stream into the data stream acceleration engine for the acceleration processing by:
transmitting, via a control channel, a configuration instruction to the data stream acceleration engine for configuration; and
inputting, via a data channel, the raw data stream to the configured data stream acceleration engine for acceleration.

19. The storage medium of claim 18, wherein the configuration of the data stream acceleration engine comprises software configuration and hardware configuration, and
the computer programs perform transmitting, via the control channel, the configuration instruction to the data stream acceleration engine for configuration by: performing the software configuration and hardware configuration of the data stream acceleration engine, wherein the computer programs execute performing the software configuration and hardware configuration of the data stream acceleration engine by:
generating, according to a type of the data stream, a corresponding software configuration instruction and a corresponding hardware configuration instruction; and
transmitting, via the control channel, the software configuration instruction and the hardware configuration instruction to perform the software configuration and the hardware configuration on the data stream acceleration engine.
